(19) United States
(12) Patent Application Publication
(10) Pub. No.: US 2002/0103795 A1
(43) Pub. Date: Aug. 1, 2002

(54) Flexible method and system for managing addresses

(76) Inventor: Katsumi Kanasaki, Tokyo (JP)

Correspondence Address: KNOBLE & YOSHIDA, LLC, Suite 1350, Eight Penn Center, 1628 John F. Kennedy Blvd., Philadelphia, PA, 19103, US

(21) Appl. No.: 10/057,046

(22) Filed: Jan. 25, 2002

(30) Foreign Application Priority Data
Jan. 30, 2001 (JP) 2001-020960
Jan. 15, 2002 (JP) 2002-6396

(51) Int. Cl. G06F 7/00; G06F 17/30

(52) U.S. Cl. 707/3; 370/475

(57) ABSTRACT

In conventional document distribution systems, user accounts are tied to address information. Because of the highly developed information distribution system, the address information needs to be maintained in a flexible and independent manner. The address generation is optionally performed in combination with a predetermined set of rules on the addresses that are stored in an independent address maintenance unit. The address maintenance unit further optionally includes a plurality of address maintenance units.

### FIELD OF THE INVENTION

The current invention is generally related to a method of and a system for maintaining an address book for telecommunication, and more particularly related to an address management that is independent from user account information.

### BACKGROUND OF THE INVENTION

It has been widely known to use an address book in using a document distribution system as also typically known as e-mail system. To facilitate the maintenance of an address book for e-mail, Japanese Patent Publication Hei 06-139 discloses a method of automatically updating the address book based upon external data. Unfortunately, since the external data is not clearly defined, the maintenance is not substantially facilitated. The maintenance also may necessarily involve a plurality of the address books. Japanese Patent Publication Hei 11-136 discloses the use of a commonly owned address book and an individual address book but fails to disclose the maintenance of these address books.

In conventional document distribution systems, addresses such as mailing addresses and return addresses are separately maintained. In many cases, the above addresses correspond to user accounts at a particular transmitting or receiving device. The user accounts are maintained for maintaining users. However, since the addresses also include telephone numbers for facsimile machines and certain folders of document receiving devices in addition to the user accounts, it is highly desirable that the address maintenance is separately performed from the user account maintenance. The separate maintenance implies that even if the mail address directly corresponds to the user account, the user maintenance and the address maintenance are still separately performed.

### SUMMARY OF THE INVENTION

In order to solve the above and other problems, according to a first aspect of the current invention, a method of flexibly managing addresses for a communication system, including the steps of: requesting an address definition from a second device to a first device; returning the address definition to the second device from the first device; obtaining a corresponding rule definition for the address definition; generating a new address definition based upon the corresponding rule definition at the second device; and returning the newly generated address from the second address to the first device.

According to a second aspect of the current invention, a system for flexibly managing addresses for a communication system, including: a third device sending a request for an address definition for use with a predetermined operation; a second device connected to said third device for receiving the request for the address definition and sending the request for the address definition; and a first device connected to said second device for returning the address definition to said second device in response to the address definition request, said first device further including a address maintenance unit for maintaining address information; wherein said second device obtaining a corresponding rule definition for the address definition and generating a new address definition based upon the corresponding rule definition, said second device returning the newly generated address to said third device.

According to a third aspect of the current invention, a computer readable medium storing computer executable instructions for performing the tasks of flexibly managing addresses for a communication system, the computer executable instructions including the steps of: requesting an address definition from a second device to a first device; returning the address definition to the second device from the first device; obtaining a corresponding rule definition for the address definition; generating a new address definition based upon the corresponding rule definition at the second device; and returning the newly generated address from the second address to the first device.

According to a fourth aspect of the current invention, a computer readable medium storing computer executable instructions for performing the tasks of flexibly managing addresses for a communication system, the computer executable instructions including the steps of: requesting an address definition from a second device to a first device; returning the address definition to the second device from the first device; obtaining a corresponding rule definition for the address definition; generating a new address definition based upon the corresponding rule definition at the second device; returning the newly generated address from the second address to the first device, the address definition each has a unique ID; determining whether or not an ID already exists; storing the newly generated address if the ID does not exist; and replacing information with the newly generated address if the ID exists.

These and various other advantages and features of novelty which characterize the invention are pointed out with particularity in the claims annexed hereto and forming a part hereof However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a diagram illustrating one preferred embodiment of the document distributing system according to the current invention.

FIG. 2 is a diagram illustrating that a plurality of devices is used to form a preferred embodiment of the address maintenance device according to the current invention.

FIG. 3A is a flow chart illustrating steps involved in a first preferred process of obtaining address information from the address maintenance device according to the current invention.

FIG. 3B is a flow chart that continues from FIG. 3A where the first preferred process continues to perform the additional steps according to the current invention. FIG. 4A is a flow chart illustrating steps involved in a second preferred process of obtaining address information from the address maintenance device according to the current invention.

FIG. 4B is a flow chart that continues from FIG. 4A where the second preferred process continues to perform the additional steps according to the current invention.

FIG. 5 is a flow chart illustrating steps involved in a preferred process of obtaining address information from the second address maintenance device according to the current invention.

### DETAILED DESCRIPTION OF THE PREFERRED EMBODIMENT(S)

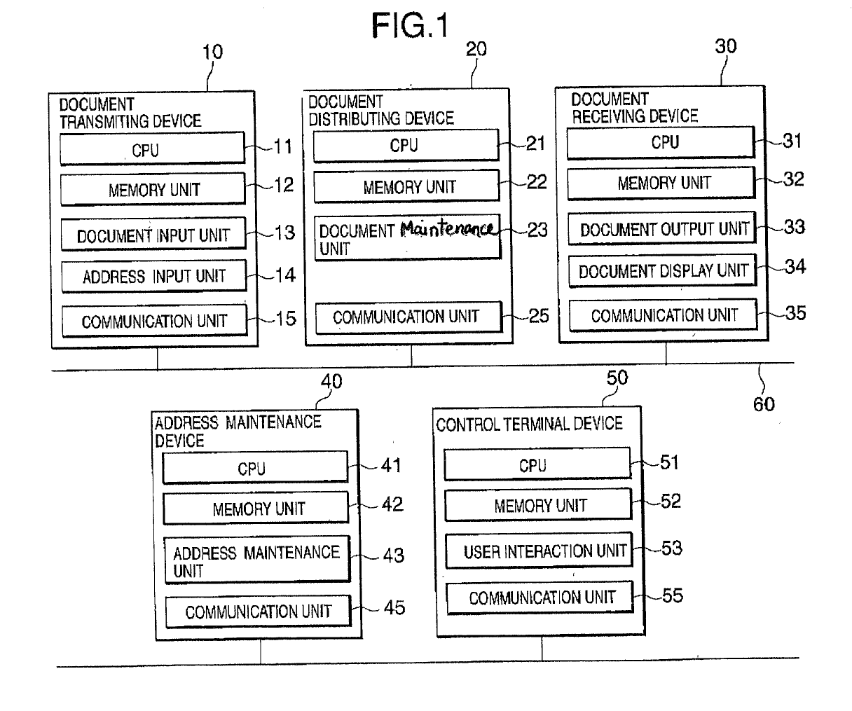

Referring now to the drawings, wherein like reference numerals designate corresponding structures throughout the views, and referring in particular to FIG. 1, a diagram illustrates one preferred embodiment of the document distributing system according to the current invention. The preferred embodiment includes a document transmitting device 10, a document distributing device 20, a document receiving device 30, an address maintenance device 40, a control terminal device 50 and communication circuit 60 for connecting the above units. The document transmitting unit 10 further includes a central processing unit (CPU) 11, a memory unit 12, a document input unit 13, an address input unit 14 and a communication unit 15. The document distributing device 20 further includes a central processing unit (CPU) 21, a memory unit 22, a document storage unit 23 and at least one communication unit 25. The document receiving device 30 further includes a central processing unit (CPU) 31, a memory unit 32, a document output unit 33, a document display unit 34 and a communication unit 35. The address maintenance device 40 further includes a central processing unit (CPU) 41, a memory unit 42, an address storage unit 43 and a communication unit 45. The control terminal device 50 further includes a central processing unit (CPU) 51, a memory unit 52, a user interaction unit 53 and a communication unit 55. The above described devices and units are connected by the communication circuit 60 to transmit and receive data among them.

Still referring to FIG. 1, some of the above described devices 10 through 50 may be combined into one device. For example, the document distributing device 20 and the address maintenance device 40 may share the CPU and the memory unit of a common server device. Similarly, the document receiving device 30 and the control terminal device 50 may share the CPU and the memory unit of a common client device. In any possible combination of the devices, the document input unit 13 of the document transmitting unit 10 inputs a document, and the document is delivered to the document distributing device 20 for storing it in the document storage unit 23. The document output unit 33 of the document receiving device 30 outputs the stored document from the document storage unit 23. Alternatively, the document display unit 34 displays the stored document. In general, there is a plurality of locations for storing the document in the document storage unit 23. To determine where to deliver the document, the address input unit 14 of the document transmitting unit 10 inputs delivery addresses. The delivery addresses are selected from the addresses that are stored in the address storage unit 43 of the address maintenance device 40. Furthermore, when a particular address is determined, the address storage unit 43 also optionally provides additional information on distribution such as the delivery location in the document storage unit 23 in the document distributing device 20. The user interaction unit 53 of the control terminal device 50 allows the user to register, update and delete the above information or data that is stored in the address storage unit 43.

The data that is stored in the address storage unit 43 of the address maintenance device 40 is contained in a table that includes address definitions. The address definitions include the following items:

Name: the name of a corresponding address. The names are displayed in an overview format, and a name is selected for inputting an address.

ID: the unique identification for distinguish each address. When the address name is used as an ID, no additional ID is necessary.

Source: When an address is generated based upon address information that is stored in another address maintenance device, the name of the address maintenance device is used as a source. On the other hand, the address is not generated, the source information is left blank.

Type: The addresses are grouped into certain classes such as individual addresses and group addresses. Type is not necessary if no group exists.

Delivery Address: Delivery is made possibly by a variety of ways such as e-mail, facsimile machines and commonly owned files. Depending upon the delivery method, delivery data defines the delivery address such as e-mail address for e-mail, a telephone number for facsimile and a folder name/a document distribution device name for a commonly owned file. For a plurality of delivery locations for the same information, one name specifies a plurality of delivery addresses. When the name specifies the delivery address, the delivery address is not necessary.

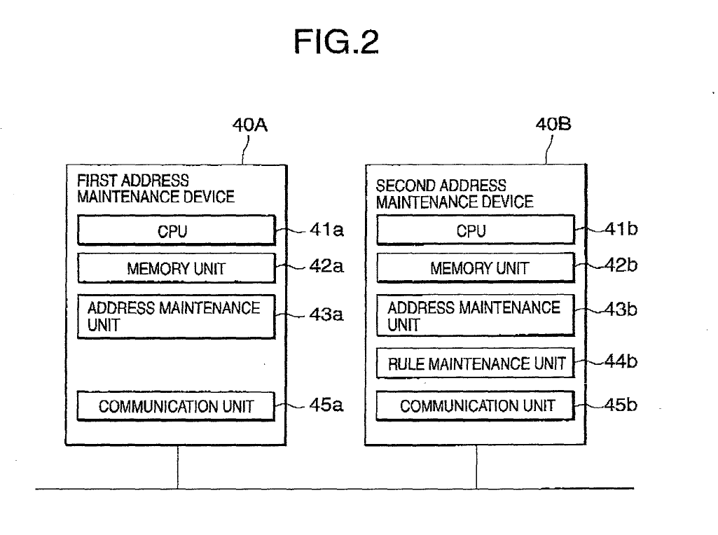

Now referring to FIG. 2, a diagram illustrates that a plurality of devices is used to form a preferred embodiment of the address maintenance device according to the current invention. The address maintenance apparatus includes a first address maintenance device 40A and a second address maintenance device 40B. The first address maintenance device 40A further includes a CPU unit 41a, a memory unit 42a, an address maintenance unit 43a and a communication unit 45a. The second address maintenance device 40B further includes a CPU unit 41b, a memory unit 42b, an address maintenance unit 43band a communication unit 45b. In addition, the second address maintenance device 40B also includes a rule maintenance unit 44b. The first address maintenance device 40A is an existing user maintenance device. In contrast to the document transmitting device 10, the document distributing device 20 and the document receiving device 30 utilizes the addresses that are stored in the second address maintenance device 40B. The information in the second address maintenance device 40B is generated from the information in the address maintenance unit 43a of the first address maintenance device 40A and in the rule maintenance unit 44b of the second address maintenance device 40B. The control terminal device 50 allows the user to have access and to modify the data in the address maintenance unit 43a of the first address maintenance device 40A, the address maintenance unit 43bof the second address maintenance device 40B and the rule maintenance unit 44b of the second address maintenance device 40B.

The rule maintenance unit 44b of the second address maintenance device 40B includes a table that contains data for rule definitions. The rule definitions are as follows:

ID: the unique identification for distinguish each rule.

Source: the name of the address maintenance device is used as a source. The address definition is generated based upon the information that is stored in the address maintenance device.

Conditions: When address definitions are obtained from the address maintenance device as a source, only address definitions that meet the specified conditions are obtained. For example, a specified type of conditions is selected.

Name Generation Method: A method is specified for converting address names. The specified name conversion method converts a name in the source address definition to a new name for a new address definition.

Type Generation Method: A method is specified for converting an address name. The specified type conversion method converts a type in the source address definition to a new type for a new address definition.

Delivery Address Generation Method: A method is specified for generating a delivery address. The specified delivery address conversion method converts an address definition in the source to a new delivery address for a new address definition.

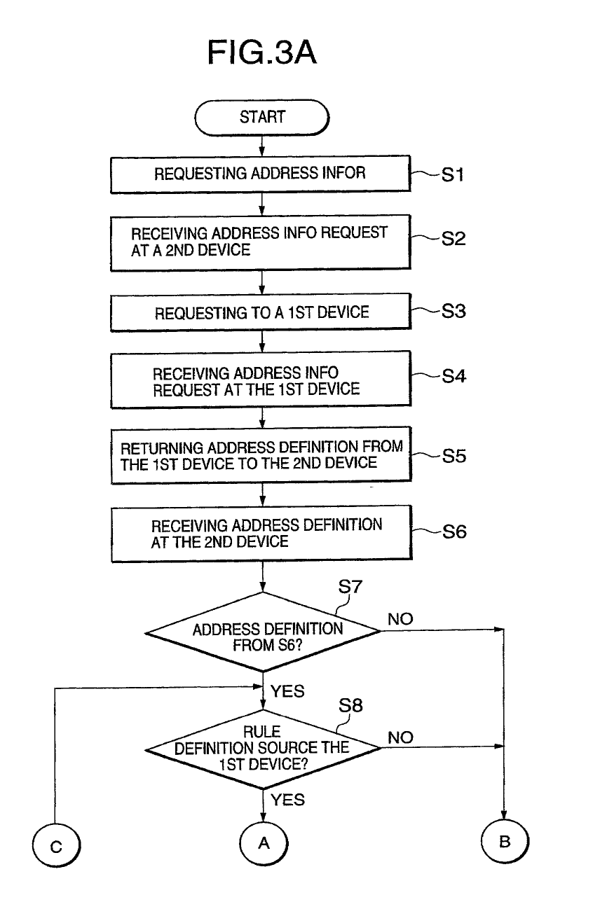

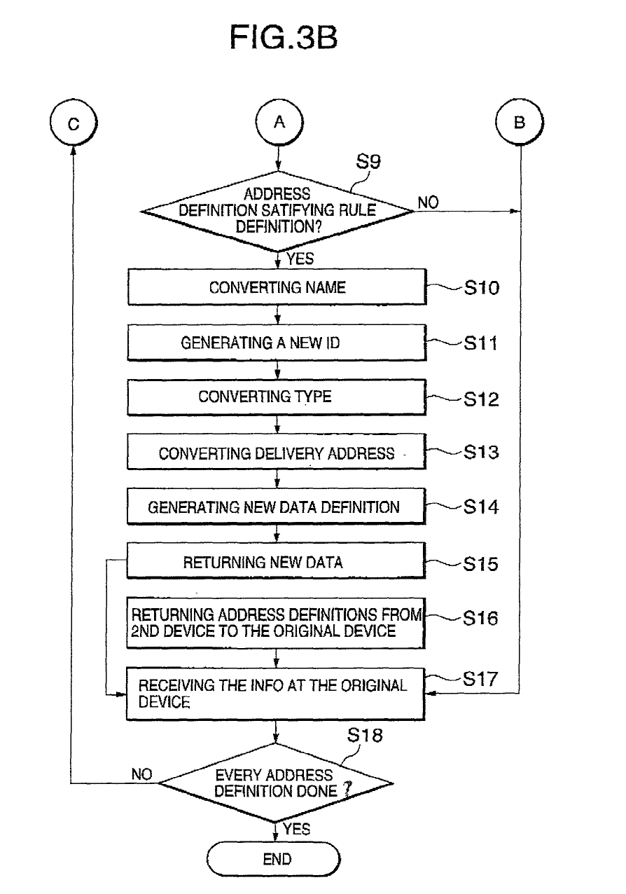

Now referring to FIG. 3A, a flow chart illustrates steps involved in a first preferred process of obtaining address information from the address maintenance device according to the current invention. The following steps will be described with respect to the units of the above described preferred embodiment as shown in FIGS. 1 and 2. In a step 1, the document transmitting device 10, the document distributing device 20 or the document receiving device 30 sends the second address maintenance device 40B an address information request. In a step 2, the second address maintenance device 40B receives the address information request. In response to the address information request, the second address maintenance device 40B in turn sends the first address maintenance device 40A an address retrieval request in a step S3. In a step S4, the first address maintenance device 40A receives the address retrieval request. The first address maintenance device 40A obtains an address definition table from the address maintenance unit 43a and returns the obtained result to the second address maintenance device 40B in a step S5. In a step S6, the second address maintenance device 40B receives the address definition table from the first address maintenance device 40A. In a step S7, it is determined whether or not an address definition is obtained from the step S6. If it is determined that the address definition is not obtained in the step S6, the first preferred process skips to a step S16 as continued onto FIG. 3B. On the other hand, if it is determined that the address definition is obtained in the step S6, it is further determined whether or not the rule definition source is the first address maintenance device 40A in a step S8. If it is determined that the rule definition source is not the first address maintenance device 40A in the step S7, the first preferred process skips to the step S17 as continued onto FIG. 3B. In the step 16, the address definitions from the address maintenance unit 43bof the second address maintenance device 40B are returned to the document transmitting device 10, the document distributing device 20 or the document receiving device 30.

Now referring to FIG. 3B, the first preferred process continues to perform the following steps according to the current invention. If it is determined that the rule definition source is the first address maintenance device 40A in the step S7, it is further determined in a step S9 whether or not the address definition satisfies the conditions that are specified in the rule definition. If it is determined in the step S9 that the conditions are not met, the first preferred process skips to the step S16. On the other hand, if it is determined in the step S9 that the conditions are met, the first preferred process now performs a series of conversions. In a step S10, by applying a name generation method of the rule definition to the address definition, a converted name is obtained. In a step S11, an ID of the address definition and the ID of the rule definition are combined to obtain a new ID. In a step S12, by applying a type generation method of the rule definition to the address definition, a converted type is obtained. Similarly, in a step S13, by applying a delivery address generation method of the rule definition to the address definition, a converted delivery address is obtained. Based upon the above newly generated data from the steps 10 through 13, new address definition is generated in a step S14. In a step S15, the newly generated address definitions are returned to the document transmitting device 10, the document distributing device 20 or the document receiving device 30. In a step S17, the document transmitting device 10, the document distributing device 20 or the document receiving device 30 receives the address definitions from the step S16 or the newly generated address definitions from the step S15. In a step S18, it is determined whether or not every address definition has been processed. For the remaining address definitions, the first preferred process returns to the step S8. If there is no remaining address definition, the preferred process terminates.

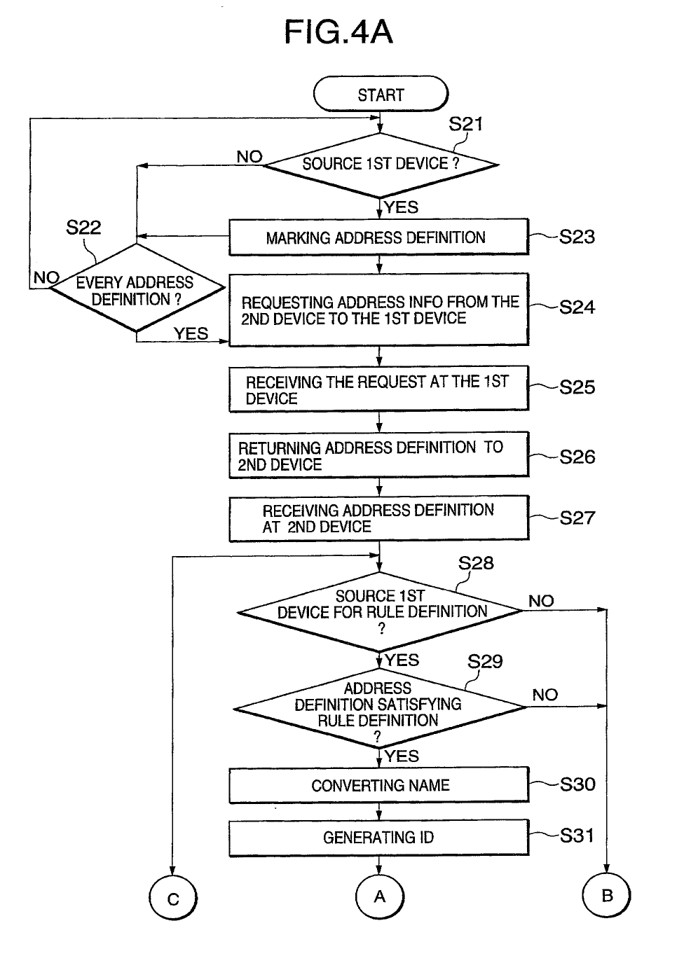

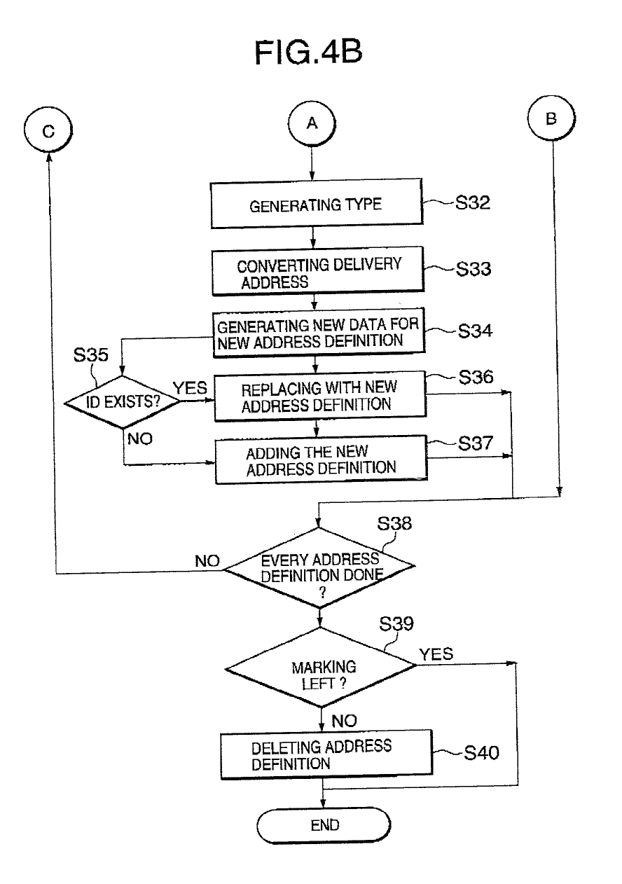

Now referring to FIG. 4A, a flow chart illustrates steps involved in a second preferred process of obtaining address information from the address maintenance device according to the current invention. The following steps will be described with respect to the units of the above described preferred embodiment as shown in FIGS. 1 and 2. In general, the second preferred process assumes that the second address maintenance device 40B receives address information from the first address maintenance device 40A and generates the address information. In a step 21, it is determined whether or not the rule definition source is the first address maintenance device 40A. If it is determined that the rule definition source is the first address maintenance device 40A, a mark is placed or a flag is marked in the address definition in a step 23 and the preferred process proceeds to a step S22. On the other hand, if it is determined that the rule definition source is not the first address maintenance device 40A, the preferred process proceeds to the step S22 to determine whether or not every address definition has been processed so far. The above steps are repeated for any remaining address definitions. Otherwise, the preferred process proceeds to a step S24, where the second address maintenance device 40B sends the first address maintenance device 40A an address information request. In a step 25, the first address maintenance device 40A receives the address information request. In response to the address information request, the first address maintenance device 40A obtains an address definition table from the address maintenance unit 43a and returns the obtained result to the second address maintenance device 40B in a step S26. In a step S27, the second address maintenance device 40B receives the address definition table from the first address maintenance device 40A.

Still referring to FIG. 4A, in a step S28, it is determined whether or not the source for the rule definition in the rule maintenance unit 44b is the first address maintenance device 40A. If it is determined in the step S28 that the source for the rule definition in the rule maintenance unit 44b is not the first address maintenance device 40A, the second preferred process proceeds to a step S38 as continued onto FIG. 3B. On the other hand, if it is determined in the step S28 that the source for the rule definition is indeed the first address maintenance device 40A, it is further determined in a step S29 whether or not the address definition satisfies the conditions that are specified in the rule definition. If it is determined in the step S29 that the conditions are not met, the preferred process skips to the step S38. On the other hand, if it is determined in the step S29 that the conditions are met, the preferred process now performs a series of conversions. In a step S30, by applying a name generation method of the rule definition to the address definition, a converted name is obtained. In a step S31, an ID of the address definition and the ID of the rule definition are combined to obtain a new ID.

Now referring to FIG. 4B, in a step S32, by applying a type generation method of the rule definition to the address definition, a converted type is obtained. Similarly, in a step S33, by applying a delivery address generation method of the rule definition to the address definition, a converted delivery address is obtained. Based upon the above newly generated data from the steps 30 through 33, new address definition is generated in a step S34. In a step S35, it is determined whether or not an address definition exists with the same ID as the above newly generated address definition in any address maintenance unit. If the address definition with the identical ID exists in the step S35, the name, type and delivery address in the address maintenance unit are respectively replaced by those of the newly generated address definition in a step S36. On the other hand, if the address definition with the identical ID does not exist in the step S35, the name, type and delivery address of the newly generated address definition is stored in the address maintenance unit in a step S37. After either the step S36 or S37, it is determined in a step S38 whether not every address definition has been processed. If any unprocessed address definition exists, the second preferred process returns to the step S28. On the other hand, all address definitions are processed, it is further determined in a step S39 whether or not the mark or flag from the step S23 exists. If any of the mark exits, the corresponding address definition is deleted from the address maintenance unit in a step S40. On the other hand, if no mark exists, the preferred process terminates without performing the step S40.

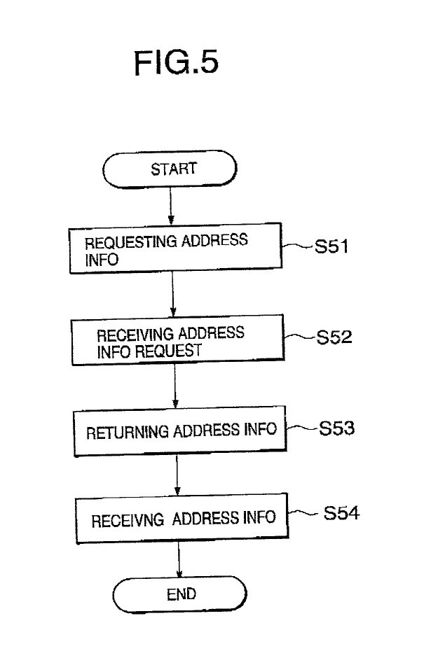

Now referring to FIG. 5, a flow chart illustrates steps involved in a preferred process of obtaining address information from the second address maintenance device 40B according to the current invention. In a step S51, the document transmitting device 10, the document distributing device 20 or the document receiving device 30 sends an address information retrieval request to the second address maintenance device 40B. In a step S52, second address maintenance device 40B receives the address information retrieval request from the step S51. In a step S53, the address information is retrieved from the address maintenance unit 43bof the second address maintenance device 40B, and the retrieved address information is returned to the document transmitting device 10, the document distributing device 20 or the document receiving device 30. Lastly, in a step S54, the document transmitting device 10, the document distributing device 20 or the document receiving device 30 receives the returned result from the second address maintenance device 40B.

As described with respect to the steps S7 through S14 in FIGS. 3A and 3B as well as the steps S26 through S37 in FIGS. 4A and 4B, the steps involved in generating the new data are now further illustrated with exemplary values in the address and rule definitions. The values and records are merely for illustrative purposes and are not limited to the following values and records. For example, the address maintenance device 40A or the first device is provided for a division names SRC. Assuming that the address maintenance unit 43a contains the following address definition:

Name: Katsumi Kanasaki

Source: empty

Type: individual

Delivery Address: kana

The address maintenance device 40B or the second device is provided for an enterprise named Ricoh, and the above division SRC is a part of the enterprise Ricoh. Assuming further that the rule maintenance unit 44b contains the following rule definition:

ID: 1

Source: SRC

Condition: Type is “individual”

Name Generation Method: Name followed by “, SRC”

ID Generation Method: SRC ID followed by “-” and Rule Definition ID

Type Generation Method: Type

Delivery Address Generation Method: Delivery Address followed by “@src.ricoh.co.jp”

In the step S8 in FIG. 3A or S28 in FIG. 4A, a set of inquires is made before new data is generated. First, it is determined whether or not the first device is a source for the rule definition. Since the value of Source in the rule definition is SRC, the first device is a source for the rule definition. Subsequently, in the step S9 in FIG. 3A or S29 in FIG. 4A, it is determined whether or not the condition as specified in the rule definition is satisfied by a corresponding value in the address definition. Since the condition specifies that Type is “individual” and Type in the address definition contains “individual,” the above second inquiry is also successfully met. Based upon the above exemplary address and rule definitions, the following new data or address definition is generated in the steps S7 through S14 in FIGS. 3A and 3B as well as the steps S26 through S37 in FIGS. 4A and 4B:

Name: Katsumi Kanasaki, SRC

ID: 100-1

Source: SRC

Type: individual

Delivery Address:kana@src.ricoh.co.jp

The above new data is generated in the following manner. As a result of the step S10 or S30, “Katsumi Kanasaki, SRC” is generated. The new Name value is generated by appending “, SRC” to Name as specified in the Name Generation Method in the above rule definition. Similarly, as a result of the step S11 or S31, the ID, “100-1” is generated. As specified in ID Generation Method, the new ID generation is obtained by appending “-” and the current rule definition ID value to the Source address definition ID value. In the step S12 or S32, Type of the new data is generated based upon the Type Generation Method of the rule definition. Although the Type value may be converted, in the above example, since the new TYPE value is specified as the value of Type in the address definition in SRC, the new TYPE value remains the same in the new data. Finally, the step S13 or S33, the Delivery Address value in the new data is generated based upon the Delivery Address Generation Method in the rule definition. As specified in the Delivery Address Generation Method, “@src.ricoh.co.jp” is appended to the Delivery Address value of the source address definition to generate “kana@src.ricoh.co.jp.”

It is to be understood, however, that even though numerous characteristics and advantages of the present invention have been set forth in the foregoing description, together with details of the structure and function of the invention, the disclosure is illustrative only, and that although changes may be made in detail, especially in matters of shape, size and arrangement of parts, as well as implementation in software, hardware, or a combination of both, the changes are within the principles of the invention to the full extent indicated by the broad general meaning of the terms in which the appended claims are expressed.

What is claimed is:

1. A method of flexibly managing addresses for a communication system, comprising the steps of:
requesting an address definition from a second device to a first device;
returning the address definition to the second device from the first device;
obtaining a corresponding rule definition for the address definition;
generating a new address definition based upon the corresponding rule definition at the second device; and
returning the newly generated address from the second address to the first device.

2. The method of flexibly managing addresses for a communication system according to claim 1 wherein the addresses include e-mail addresses, document folders, telephone number and fax numbers.

3. The method of flexibly managing addresses for a communication system according to claim 1 wherein the first device is an existing user account management unit for user account information.

4. The method of flexibly managing addresses for a communication system according to claim 1 wherein the second device is an address maintenance unit that corresponds to the existing user account management unit for managing address information.

5. The method of flexibly managing addresses for a communication system according to claim 4 wherein the address maintenance unit manages delivery methods by adding a new delivery method.

6. The method of flexibly managing addresses for a communication system according to claim 5 wherein the new delivery method is specified in the rule definition.

7. The method of flexibly managing addresses for a communication system according to claim 6 wherein the rule definition further includes an ID value, a Source value, a Condition value, a Name Generation Method value, and a Type Generation Method value.

8. The method of flexibly managing addresses for a communication system according to claim 4 wherein the address maintenance unit manages delivery methods by deleting an existing delivery method.

9. The method of flexibly managing addresses for a communication system according to claim 4 wherein the address maintenance unit updates the address information based upon the user account information.

10. The method of flexibly managing addresses for a communication system according to claim 1 wherein said generating the new address definition is performed prior to said requesting the address definition.

11. The method of flexibly managing addresses for a communication system according to claim 1 wherein the address definition each has a unique ID and further comprises additional steps of.
determining whether or not an ID already exists;
storing the newly generated address if the ID does not exist; and
replacing information with the newly generated address if the ID exists.

12. A system for flexibly managing addresses for a communication system, comprising:
a third device sending a re quest for an address definition for u se with a predetermined operation;
a second device connected to said third device for receiving the request for the address definition and sending the request for the address definition; and
a first device connected to said second device for returning the address definition to said second device in response to the address definition request, said first device further including a address maintenance unit for maintaining address information; wherein said second device obtaining a corresponding rule definition for the address definition and generating a new address definition based upon the corresponding rule definition, said second device returning the newly generated address to said third device.

13. The system for flexibly managing addresses for a communication system according to claim 12 wherein said address maintenance unit manages e-mail addresses, document folders, telephone number and fax numbers.

14. The system for flexibly managing addresses for a communication system according to claim 12 wherein said second device includes an existing user account management unit for managing existing user account information.

15. The system for flexibly managing addresses for a communication system according to claim 14 wherein said address maintenance unit manages the address information for the existing user account information.

16. The system for flexibly managing addresses for a communication system according to claim 15 wherein the address maintenance unit manages delivery methods by adding a new delivery method.

17. The system for flexibly managing addresses for a communication system according to claim 15 wherein the address maintenance unit manages delivery methods by deleting an existing delivery method.

18. The system for flexibly managing addresses for a communication system according to claim 16 wherein the address maintenance unit additionally manages an ID value, a Source value, a Condition value, a Name Generation Method value, and a Type Generation Method value.

19. The system for flexibly managing addresses for a communication system according to claim 15 wherein the address maintenance unit updates the address information based upon the user account information.

20. The system for flexibly managing addresses for a communication system according to claim 12 wherein the address maintenance unit maintains an unique ID for the address definition and further determines whether or not an ID already exists, the address maintenance unit storing the newly generated address if the ID does not exist, the address maintenance unit replacing information with the newly generated address if the ID exists.

21. A computer readable medium storing computer executable instructions for performing the tasks of flexibly managing addresses for a communication system, the computer executable instructions comprising the steps of:
requesting an address definition from a second device to a first device;
returning the address definition to the second device from the first device;
obtaining a corresponding rule definition for the address definition;
generating a new address definition based upon the corresponding rule definition at the second device; and
returning the newly generated address from the second address to the first device.

22. A computer readable medium storing computer executable instructions for performing the tasks of flexibly managing addresses for a communication system, the computer executable instructions comprising the steps of:
requesting an address definition from a second device to a first device;
returning the address definition to the second device from the first device;
obtaining a corresponding rule definition for the address definition;
generating a new address definition based upon the corresponding rule definition at the second device;
returning the newly generated address from the second address to the first device, the address definition each has a unique ID;
determining whether or not an ID already exists;
storing the newly generated address if the ID does not exist; and
replacing information with the newly generated address if the ID exists.
